(19) United States
(12) Patent Application Publication
(10) Pub. No.: US 2021/0123570 A1
(43) Pub. Date: Apr. 29, 2021

(54) LED LIGHTING DEVICE

(71) Applicants: SHANGHAI SANSI ELECTRONIC ENGINEERING CO. LTD, SHANGHAI (CN); JIASHAN SANSI OPTOELECTRONIC TECHNOLOGY CO. LTD., JIASHAN COUNTRY, ZHEJIANG (CN); SANSI OPTOELECTRONICS TECHNOLOGY (SHANGHAI) CO. LTD., SHANGHAI (CN); SHANGHAI SANSI TECHNOLOGY CO. LTD., SHANGHAI (CN)

(72) Inventors: BISHOU CHEN, SHANGHAI (CN); YANQING GUAN, SHANGHAI (CN); AIQUN CHENG, SHANGHAI (CN); SHAN LI, SHANGHAI (CN)

(73) Assignees: SHANGHAI SANSI ELECTRONIC ENGINEERING CO. LTD, SHANGHAI (CN); JIASHAN SANSI OPTOELECTRONIC TECHNOLOGY CO. LTD., JIASHAN COUNTRY, ZHEJIANG (CN); SANSI OPTOELECTRONICS TECHNOLOGY (SHANGHAI) CO. LTD., NANHUI NEW CITY (CN); SHANGHAI SANSI TECHNOLOGY CO. LTD., SHALNGHAI (CN)

(21) Appl. No.: 17/252,256

(22) PCT Filed: Nov. 23, 2018
(86) PCT No.: PCT/CN2018/117206

§ 371 Date: Dec. 14, 2020

(30) Foreign Application Priority Data
Sep. 12, 2018 (CN) 201821493032X
Sep. 12, 2018 (CN) 2018110633259

(51) Int. Cl. F21K 9/232; F21K 9/238; F21V 29/70

(52) U.S. Cl. CPC F21K 9/232; F21Y 2115/10; F21V 29/70; F21K 9/238

(57) ABSTRACT

An LED lighting device provided by this application includes: a light source carrier, configured to carry an LED light source module; and at least one circuit carrier, configured to carry a circuit electrically connected to the LED light source module. The light source carrier and the circuit carrier are both made of a ceramic material and have an extremely high insulation coefficient and thermal conductivity.

### BACKGROUND OF THE PRESENT INVENTION

### Field of Invention

This application relates to the technical field of LED lighting, and in particular to an LED lighting device.

### Description of Related Arts

Major heat dissipation carriers commonly used in current LED lamps are metal, which is poor in insulation performance and low in safety factor.

Moreover, PCB or aluminum substrates are usually used as carriers of connection circuits. The PCB boards and aluminum substrates have complex manufacturing processes and poor thermal conductivity and heat dissipation performance.

In view of this situation, how to improve the overall safety and heat dissipation performance of lamps has become urgent in the industry.

### SUMMARY OF THE PRESENT INVENTION

In view of the foregoing disadvantages in the prior art, an object of this application is to provide an LED lighting device, so as to resolve the problem in the prior art by using ceramic as a light source carrier and a circuit carrier.

To accomplish the above and other related objects, this application provides an LED lighting device, comprising: a light source carrier, configured to carry an LED light source module; and at least one circuit carrier, configured to carry a circuit electrically connected to the LED light source module, where the light source carrier and the circuit carrier are both made of a ceramic material.

In an embodiment of this application, the circuit is a printed circuit printed on the circuit carrier.

In an embodiment of this application, the light source carrier and the circuit carrier are disposed integrally or combined with each other.

In an embodiment of this application, the light source carrier and the circuit carrier are connected through a positioning structure.

In an embodiment of this application, the positioning structure comprises a socket and an insertion portion coordinating with each other, wherein one of the socket and the insertion portion is located in the light source carrier, and the other is located in the circuit carrier.

In an embodiment of this application, the circuit and the LED light source module are electrically connected through a conductor printed on the light source carrier and the circuit carrier; or the light source carrier and the circuit carrier are each provided with a slot portion for accommodating a conductor that electrically connects the circuit and the LED light source module.

In an embodiment of this application, the light source carrier and the circuit carrier are disposed in a split manner.

In an embodiment of this application, the light source carrier and the circuit carrier are disposed parallel or perpendicular to each other.

In an embodiment of this application, a hard or flexible conductor is disposed across the light source carrier and the circuit carrier, the conductor electrically connecting the LED light source module and the circuit.

In an embodiment of this application, the LED light source module comprises a positive end and a negative end, wherein a pair of conductors is connected to the positive end and the negative end.

In an embodiment of this application, the circuit comprises a driving circuit electrically connected to the LED light source module.

In an embodiment of this application, the circuit further comprises a functional circuit electrically connected to or integrated with the driving circuit, the functional circuit comprises one or more of a lightning protection circuit, a surge protection circuit, an electromagnetic compatibility circuit, a dimming circuit, a color temperature adjusting circuit, and a brightness adjusting circuit.

In an embodiment of this application, the circuit carrier is a plate body in one or a combination of the following shapes: a square, a triangle, a circle, a trapezoid, a circle, and a regular polygon.

In an embodiment of this application, one or more external surfaces except a bearing surface of the light source carrier for bearing the LED light source module are in the shape of a plane, or a cambered surface, or a concave-convex surface formed by a plurality of planes and/or cambered surfaces connected together.

In an embodiment of this application, the LED lighting device is a bulb lamp.

As described above, an LED lighting device provided by this application comprises: a light source carrier, configured to carry an LED light source module; and at least one circuit carrier, configured to carry a circuit electrically connected to the LED light source module. The light source carrier and the circuit carrier are both made of a ceramic material and have an extremely high insulation coefficient and thermal conductivity. By using ceramic as a carrier of an LED light source module, double effects of circuit connection and heat dissipation are achieved. Moreover, ceramic is also used, in substitution of a PCB board, as a carrier for carrying a driving/functional circuit connected to the LED light source module and also achieves heat dissipation for the driving/functional circuit. As such, not only the overall safety performance but also the overall heat dissipation performance of a lamp is improved.

### BRIEF DESCRIPTION OF THE DRAWINGS

FIG. 1A is a structural diagram of connection between a light source carrier and a circuit carrier according to a first embodiment of this application.

FIG. 1B is a structural diagram of connection between a light source carrier and a circuit carrier according to a second embodiment of this application.

FIG. 1C is a structural diagram of connection between a light source carrier and a circuit carrier according to a third embodiment of this application.

FIG. 1D is a structural diagram of connection between a light source carrier and a circuit carrier according to a fourth embodiment of this application.

FIG. 2A is a structural diagram of a light source carrier according to a first embodiment of this application.

FIG. 2B is a structural diagram of a light source carrier according to a second embodiment of this application.

FIG. 2C is a structural diagram of a light source carrier according to a third embodiment of this application.

### DETAILED DESCRIPTION OF THE PREFERRED EMBODIMENTS

Implementations of this application are illustrated below through specific examples. Persons skilled in the art can easily understand other advantages and efficacy of this application according to the content disclosed in this specification. This application can also be implemented or applied through other different specific implementations. Various modifications or variations can also be made on details in this specification based on different opinions and applications without departing from the spirit of this application. It should be noted that the embodiments in the following and features in the embodiments can be combined with each other if no conflict occurs.

It should be noted that, the figures provided in the following embodiments merely illustrate the basic conception of this application schematically. Therefore, the figures only show components related to this application, and are not drawn according to the quantity, shapes and sizes of components during actual implementation. The pattern, quantity and ratio of components during actual implementation can be changed arbitrarily, and the component layout may also be more complex.

The technical solution of this application is applied to an LED lighting device. The LED lighting device includes various lamps, such according to door lamps and indoor lamps. The indoor lamps include, for example, a common street lamp, a solar street lamp, a yard lamp, an underground lamp, a wall washer lamp, a tunnel lamp, a landscape lamp, a lawn lamp, an underwater lamp, a fountain lamp, a guardrail tube, a stage lamp, a mobile lamp, a traffic light, an automobile lamp, and a light bar/strip. The indoor lamps include: a down light, a bulb lamp, a candle lamp, a modulator tube, a grille lamp, a bean container lamp, a panel lamp, a ceiling lamp, a recessed lamp, a counter lamp, a flush mounted ceiling lamp, a pendant lamp, a wall lamp, a floor lamp, a table lamp, a kitchen or bathroom lamp, a mirror lamp, an emergency lamp, a bath heater, an astral lamp, a searchlight, a spotlight, a projection lamp, a footlight, and the like.

The LED lighting device includes an LED light source module and a driving circuit thereof.

The LED light source module includes an LED light source chip, and may further comprise a lens in coordination with the LED light source chip. The driving circuit is configured to drive the LED light source module to work in a stabilize state and protect the LED light source module. The LED lighting device further includes some functional circuits, for example, one or more of a lightning protection circuit, a surge protection circuit, an electromagnetic compatibility circuit, a dimming circuit, a color temperature adjusting circuit, and a brightness adjusting circuit. The functional circuit is electrically connected to or integrated with the driving circuit.

In the LED lighting device, a light source carrier for carrying the LED light source module is provided correspondingly; circuit carriers for carrying the driving circuit and the functional circuit are provided.

In the prior art, a metal carrier is generally used as a carrier of the LED light source module, and PCB boards are generally used as carriers of the driving circuit and the functional circuit. The carriers have poor insulation performance, poor thermal conductivity and poor heat dissipation performance, and therefore may cause some problems.

In view of the problem, this application provides an LED lighting device, which may be one of the foregoing indoor lamps or indoor lamps. The LED lighting device includes: a light source carrier, configured to carry an LED light source module; and at least one circuit carrier, configured to carry a circuit electrically connected to the LED light source module. In order to solve the problem in the prior art, the light source carrier and the circuit carrier in the LED lighting device according to this application are made of ceramic material.

In other words, in the LED lighting device according to this application, the light source carrier is made of ceramic instead of metal in the existing technical solution, and the safety and stability of the LED light source module as well as the electrical circuit connected thereto are effectively improved because of good insulation performance and thermal conductivity of the ceramic. Moreover, the circuit carrier is made of ceramic instead of a PCB board or an aluminum substrate in the existing technical solution, and the safety and stability of the circuit (that is, the driving circuit and/or the functional circuit) are also effectively improved.

In an embodiment of this application, the circuit is a printed circuit printed on the circuit carrier. In other words, ceramic is used as a substrate, and copper wires and the like are printed on the ceramic. As such, protection and heat dissipation for the circuit can be effectively enhanced while a high level of integration of the original integrated circuit is retained.

In some LED lighting devices with small volumes, for example, in a bulb lamp, the light source carrier and the circuit carrier need to be arranged in an extremely small space. Therefore, requirements are proposed for positions, a connection structure, and the like of the light source carrier and the circuit carrier.

A bulb lamp is used as an example in the following. Layout manners of the light source carrier and the circuit carrier are showed through embodiments.

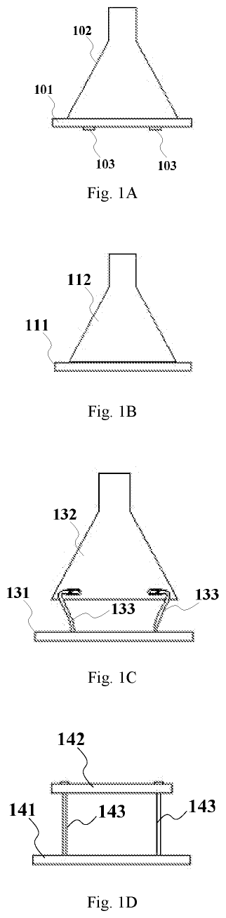

As shown in FIG. 1A, the light source carrier 101 and the circuit carrier 102 are combined with each other. Specifically, the combination is, for example, direct connection through a positioning structure. In this embodiment, the positioning structure includes a socket and an insertion portion 103 coordinating with each other. The socket may be provided in the light source carrier 101, and the insertion portion 103 may be provided in the circuit carrier 102. The insertion portion 103 is inserted in the socket to complete positioning of the light source carrier 101 and the circuit carrier 102.

Optionally, two or more insertion portions 103 and sockets may be provided. More preferably, spacing between the insertion portions 103 may be different from spacing between the sockets, or the size of the insertion portion 103 may be slightly larger than that of the socket, so that when the insertion portion 103 is jointed with the socket, a friction between the insertion portion 103 and the socket can be increased by using a deformation force generated by slight deformation of the insertion portion 103 or an extrusion force generated by an interference fit between the insertion portion 103 and the socket, thereby implementing positioning of the circuit carrier 102 and the light source carrier 101.

Optionally, the positioning structure may be a clamping structure. For example, the insertion portion 103 is a hook, which enters the insertion portion 103 from a front side of the circuit carrier 102, rebounds upon reaching a rear side of the circuit carrier 102, and hence is hooked on the rear side of the circuit carrier 102 as a barb, thereby implementing positioning of the light source carrier 101 and the circuit carrier 102 in various orientations.

As shown in FIG. 1B, the light source carrier 111 and the circuit carrier 112 may be integrated. For example, the light source carrier 111 and the circuit carrier 112 are integrally formed by using the same mold during ceramic firing. Alternatively, the light source carrier 111 and the circuit carrier 112 may be sintered or bonded together.

In the embodiments shown in FIG. 1A and FIG. 1B, the light source carrier 101 is directly connected to the circuit carrier 102, the light source carrier 111 is directly connected to the circuit carrier 112. Therefore, during layout of a conductor electrically connecting the LED light source module and the circuit (the printed circuit or the flexible circuit), the conductor may be directly laid on the light source carrier 101, 111 and the circuit carrier 102, 112 that are made of a ceramic material. For example, the conductor electrically connecting the LED light source module and the circuit is laid on the light source carrier 101, 111 and the circuit carrier 102, 112 in the form of a printed circuit; or slots are provided on the light source carrier 101, 111 and the circuit carrier 102, 112 for insertion of a conductive circuit electrically connecting the LED light source module and the circuit.

As such, ceramic can be used as a carrier of the conductor to achieve protection and heat dissipation for the conductor.

In an embodiment of this application, the circuit and the LED light source module are electrically connected through a conductor printed on the light source carrier 101, 111 and the circuit carrier 102, 112; alternatively, the light source carrier 101, 111 and the circuit carrier 102, 112 are each provided with a slot portion for accommodating a conductor that electrically connects the circuit and the LED light source module.

In the embodiments shown in FIG. 1A and FIG. 1B, the light source carrier 101 may be disposed parallel or perpendicular to the circuit carrier 102, the light source carrier 111 may be disposed parallel or perpendicular to the circuit carrier 112, to avoid damage to circuit carrier 102, 112 caused by relative movement of the light source carrier 101 that occurs when an external force towards the circuit carrier 102, 112 is applied on the light source carrier 101, 111. A reinforcing rib may be further disposed between the circuit carrier 102, 112 and the light source carrier 101, 111 to avoid the relative movement.

It should be noted that, although only one circuit carrier is displayed in the foregoing embodiment, there may be a plurality of circuit carriers in practice, and the circuit carriers may be disposed on one light source carrier in a many-to-one manner, thereby improving utilization of the internal space of the LED lighting device.

In other embodiments of this application, the light source carrier and the circuit carrier may also be disposed in a split manner. To implement electrical connection between the LED light source module and the circuit in such a layout, a hard or flexible conductor is disposed across the light source carrier and the circuit carrier. The flexible conductor is, for example, a wire; the hard conductor is, for example, a pin.

As shown in FIG. 1C, in this embodiment, the conductor 133 may be a wire, two ends of the wire are respectively fixed to the light source carrier 131 and the circuit carrier 132 through welding, to electrically connect the LED light source module and the circuit.

In this embodiment, the light source carrier 131 and the circuit carrier 132 are preferably disposed perpendicular to each other. Optionally, because the light source carrier 131 and the circuit carrier 132 are disposed in a split manner and connected through a flexible conductor 133, relative positions or postures thereof are changeable. Because the light source carrier 131 and the circuit carrier 132 are not parallel to each other, when the circuit carrier 132 is a plate body, side surfaces of the circuit carrier 132 are relatively narrow, and it is inconvenient to dispose a hard conductor 133 to complete the electrical connection.

As shown in FIG. 1D, in this embodiment, the light source carrier 141 and the circuit carrier 142 are disposed parallel to each other, and a hard conductor 143 (such as a pin) can be used to implement relative positioning of the light source carrier 141 and the circuit carrier 142, and the electrical connection between the LED light source module and the circuit.

The LED light source module comprises a positive end and a negative end. Therefore, it can be seen that in the embodiments shown in FIG. 1C and FIG. 1D, a pair of conductors 133, 143 respectively connected to the positive end and the negative end is provided. The other end of the pair of conductors 133, 143 is connected to two electrode terminals of the circuit on the circuit carrier 132, 142, for example, positive and negative electrodes of a power output end, where the negative electrode of the power output end may be grounded.

It should be noted that, although no conductor is shown in FIG. 1A and FIG. 1B, in the embodiments shown in FIG. 1A and FIG. 1B, when the LED light source module comprises a positive end and a negative end, there are also two conductors, where the two conductors have one end connected to the positive end and the negative end of the LED light source module, and the other end connected to two electrode terminals of the circuit on the circuit carrier 102, 112, for example, a power output positive end and a power output negative end, and the power output negative end may be grounded.

In an embodiment of this application, the circuit carrier is a plate body in one or a combination of two or more of the following shapes: a square, a triangle, a circle, a trapezoid, a circle, and a regular polygon. The combination of shapes is, for example, a square connected to a trapezoid as shown in FIG. 1A to FIG. 1C.

In an embodiment of this application, one or more external surfaces except a bearing surface of the light source carrier for bearing the LED light source module may have varying structures according to different degrees of heat dissipation requirements.

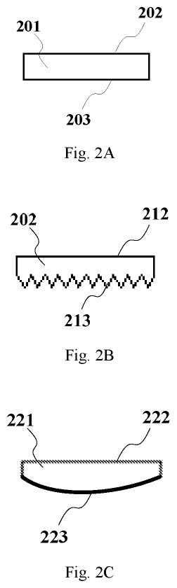

As shown in FIG. 2A, in this embodiment, when the heat dissipation is not urgent, the rear side 203 of the bearing surface 202 of the light source carrier 201 may be a plane.

As shown in FIG. 2B, in this embodiment, in order to increase the heat dissipation area, the rear side 213 of the bearing surface 212 of the light source carrier 211 may be a cambered surface, and preferably an outward protruding cambered surface as shown in the figure.

As shown in FIG. 2C, in this embodiment, in order to increase the heat dissipation area, the rear side 223 of the bearing surface 222 of the light source carrier 221 may be a concave-convex surface formed by a plurality of planes connected together, for example, a saw-toothed surface formed by a plurality of teeth shown in the figure. In other embodiments, the top of each tooth may be a flat surface, so as to form a concave-convex surface with a larger heat dissipation area.

Similarly, the concave-convex surface may also be formed by a plurality cambered surfaces connected together or formed by a plurality of planes and cambered surfaces connected together, which can be implemented by persons skilled in the art according to the idea of this application. Details are not elaborated herein.

It should be particularly noted that, although embodiments of FIG. 2A to FIG. 2C only show the shape of the rear side 203, 213, 223 of the bearing surface 202, 212, 222 to meet different heat dissipation requirements, in other embodiments, other surfaces of the light source carrier 201, 211, 221, such as side surfaces, may also have varying shapes, and are not limited to the foregoing embodiments and the figures.

It can be learned from the foregoing description that, a plurality of carrier combinations can be derived from permutations of the varying shapes and structures of the light source carrier and the circuit carrier. For example, the circuit carrier has five shapes (for example, a square, a triangle, a circle, a combination of a square and a trapezoid, and a regular polygon), and the light source carrier has three structures (for example, the rear side of the bearing surface is a plane, a cambered surface, or a saw-toothed surface); in this case, a total of 5*3=15 carrier combinations can be generated, and can provide options for structure and layout requirements of different LED lighting devices, thereby greatly enhancing the diversity of the layout, for example, improving the design convenience and efficiency.

In conclusion, an LED lighting device provided by this application comprises: a light source carrier, configured to carry an LED light source module; and at least one circuit carrier, configured to carry a circuit electrically connected to the LED light source module. The light source carrier and the circuit carrier are both made of a ceramic material and have an extremely high insulation coefficient and thermal conductivity. By using ceramic as a carrier of an LED light source module, double effects of circuit connection and heat dissipation are achieved. Moreover, ceramic is also used, in substitution of a PCB board, as a carrier for carrying a driving/functional circuit connected to the LED light source module and also achieves heat dissipation for the driving/functional circuit. As such, not only the overall safety performance but also the overall heat dissipation performance of a lamp is improved.

The foregoing embodiments are only to illustrate the principle and efficacy of this application exemplarily, and are not to limit this application. Any person skilled in the art can make modifications or variations on the foregoing embodiments without departing from the spirit and scope of this application. Accordingly, all equivalent modifications or variations completed by persons of ordinary skill in the art without departing from the spirit and technical thinking disclosed by this application should fall within the scope of claims of this application.

1. An LED lighting device, comprising:
a light source carrier, configured to carry an LED light source module; and
at least one circuit carrier, configured to carry a circuit electrically connected to the LED light source module;
wherein the light source carrier and the circuit carrier are both made of a ceramic material.

2. The LED lighting device according to claim 1, wherein the circuit is a printed circuit printed on the circuit carrier.

3. The LED lighting device according to claim 1, wherein the light source carrier and the circuit carrier are disposed integrally or combined with each other.

4. The LED lighting device according to claim 3, wherein the light source carrier and the circuit carrier are connected through a positioning structure.

5. The LED lighting device according to claim 4, wherein the positioning structure comprises a socket and an insertion portion coordinating with each other, wherein one of the socket and the insertion portion is located in the light source carrier, and the other is located in the circuit carrier.

6. The LED lighting device according to claim 1, wherein the circuit and the LED light source module are electrically connected through a conductor printed on the light source carrier and the circuit carrier; or the light source carrier and the circuit carrier are each provided with a slot portion for accommodating a conductor that electrically connects the circuit and the LED light source module.

7. The LED lighting device according to claim 1, wherein the light source carrier and the circuit carrier are disposed in a split manner.

8. The LED lighting device according to claim 3, wherein the light source carrier and the circuit carrier are disposed parallel or perpendicular to each other.

9. The LED lighting device according to claim 7, wherein a hard or flexible conductor is disposed across the light source carrier and the circuit carrier, wherein the conductor electrically connects the LED light source module and the circuit.

10. The LED lighting device according to claim 6, wherein the LED light source module comprises a positive end and a negative end, wherein a pair of conductors is connected to the positive end and the negative end.

11. The LED lighting device according to claim 1, wherein the circuit comprises a driving circuit electrically connected to the LED light source module.

12. The LED lighting device according to claim 11, wherein the circuit further comprises a functional circuit electrically connected to or integrated with the driving circuit, wherein the functional circuit comprises one or more of a lightning protection circuit, a surge protection circuit, an electromagnetic compatibility circuit, a dimming circuit, a color temperature adjusting circuit, and a brightness adjusting circuit.

13. The LED lighting device according to claim 1, wherein the circuit carrier is a plate body in one or a combination of the following shapes: a square, a triangle, a circle, a trapezoid, a circle, and a regular polygon.

14. The LED lighting device according to claim 1, wherein one or more external surfaces except a bearing surface of the light source carrier for bearing the LED light source module are in the shape of a plane, or a cambered surface, or a concave-convex surface formed by a plurality of planes and/or cambered surfaces connected together.

15. The LED lighting device according to claim 1, wherein the LED lighting device is a bulb lamp.

16. The LED lighting device according to claim 7, wherein the light source carrier and the circuit carrier are disposed parallel or perpendicular to each other.

17. The LED lighting device according to claim 9, wherein the LED light source module comprises a positive end and a negative end, wherein a pair of conductors is connected to the positive end and the negative end.
